(19) United States
(12) Patent Application Publication
(10) Pub. No.: US 2026/0245862 A1
(43) Pub. Date: Aug. 20, 2026

(54) METHOD OF MANUFACTURING OF MATERIAL FOR GRAPHITIC CARBON COATED GRAPHITE ELECTRODE

(71) Applicant: EPSILON ADVANCED MATERIALS PRIVATE LIMITED, Maharashtra (IN)

(72) Inventor: Chinnasamy Natarajan, Tamil Nadu (IN)

(73) Assignee: EPSILON ADVANCED MATERIALS PRIVATE LIMITED, Maharashtra (IN)

(21) Appl. No.: 19/145,162

(22) PCT Filed: Jan. 4, 2024
(86) PCT No.: PCT/IB2024/050073

§ 371 Date: Jul. 1, 2025

(30) Foreign Application Priority Data
Jan. 4, 2023 (IN) 202321000522

(51) Int. Cl. H01M 4/04; H01M 4/587

(52) U.S. Cl. CPC H01M 4/0471; H01M 4/587

(57) ABSTRACT

The present disclosure provides a method (200) of manufacturing a graphite-based material for an electrode. The method (200) includes the steps of: shaping a block material comprising graphite into a raw material block; coating the raw material block with a second material, wherein the second material comprises carbon; and heating the coated raw material block to enable a graphitization of the coated raw material block to produce a carbon coated graphite-based material. The coated raw material block is heated to a temperature of greater than about 2600° C. in order to remove impurities. Such a process yields a graphite powder with a high purity content, of greater than about 99.95%. The present disclosure further provides an electrode made of the graphite-based material.

### TECHNICAL FIELD

The present disclosure generally relates to negative electrodes for Lithium-ion batteries. In particular, the present disclosure relates to a means to produce graphitic carbon coated, high-quality, negative electrodes for Lithium-ion batteries.

### BACKGROUND

Background description includes information that may be useful in understanding the present invention. It is not an admission that any of the information provided herein is prior art or relevant to the presently claimed invention, or that any publication specifically or implicitly referenced is prior art.

Typically, negative electrodes for Lithium-ion batteries are graphite electrodes. Conventionally, a graphite electrode is made from synthetic graphite or by milling and shaping a natural graphite flake, purifying it with an acid wash/treatment, coating it with carbon, and heat treating it at high temperatures of about 1000 to 1200 degrees Centigrade. Though, a high purity, of greater than 99.9%, is achieved for the graphite powder, the process used may require additional facilities and resources. For example, acid washing, filtering and drying facilities requires large quantities of water, and an effluent treatment plant.

### OBJECTS OF THE INVENTION

An object of the present invention is to provide a method to manufacture a graphite-based material for making an electrode.

Another object of the present invention is to provide a method to manufacture a high-purity graphite-based material for an electrode.

Another object of the present invention is to provide a method to manufacture a high purity graphite-based material by eliminating chemical purification process, which makes this process as eco-friendly.

Another object of the present invention is to provide a method to manufacture a graphite-based material for an electrode that has a high tap density.

### SUMMARY

The present disclosure generally relates to negative electrodes for Lithium-ion batteries. In particular, the present disclosure relates to a means to produce graphitic carbon coated, high-quality, negative electrodes for Lithium-ion batteries.

In an aspect, the present disclosure provides a method of manufacturing a graphite-based material for an electrode. The method includes milling and shaping a block material including graphite flake into a spherical graphite powder. The method further includes coating the raw material block with a second material, wherein the second material is a carbon source, such as coal tar pitch, petroleum tar pitch and/or polymer-based material. The method further includes heating the carbon source coated graphite powder to enable the carbonization followed by graphitization of the coated carbon source on graphite particle to produce a graphitic carbon coated graphite-based material.

In some embodiments, the block material includes a natural graphite flake.

In some embodiments, the block material is shaped using any or a combination of milling and spherical milling.

In some embodiments, the second material includes pitch and/or polymer material.

In some embodiments, the coated raw material powder is heated to a temperature of between about 2500 degrees Centigrade (° C.) and 3000° C.

In some embodiments, the produced carbon coated graphite-based material has a tap density of between about 1.1 grams per cubic centimeter (g/cc) and about 1.25 g/cc.

In some embodiments, the produced carbon coated graphite-based material has a capacity of between about 360 milliampere-hour per gram (mAh/g) and about 370 mAh/g.

In some embodiments, the produced carbon coated graphite-based material has a purity equal to greater than about 99.95%.

In another aspect, the present disclosure provides an electrode made from a graphite-based material. The graphite-based material is manufactured by shaping a block material including graphite into a raw material block. The graphite-based material is further manufactured by coating the raw material block with a second material, wherein the second material includes carbon. The graphite-based material is further manufactured by heating the coated raw material block to enable a graphitization of the coated raw material block to produce a carbon coated graphite-based material.

In some embodiments, the electrode has an efficiency of between about 92% and about 95%.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates a schematic flow diagram for a conventional process for producing a material for making a graphite electrode;

FIG. 2 illustrates a schematic flow diagram for a method to manufacture a graphite-based material for an electrode, according to an embodiment of the present disclosure; and

FIG. 3 illustrates an exemplary schematic flow diagram for a process for producing a material for making a graphite electrode.

FIG. 4 illustrates the Raman spectra of graphitic carbon coated graphite made as per our process and amorphous carbon coated graphite by conventional process.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

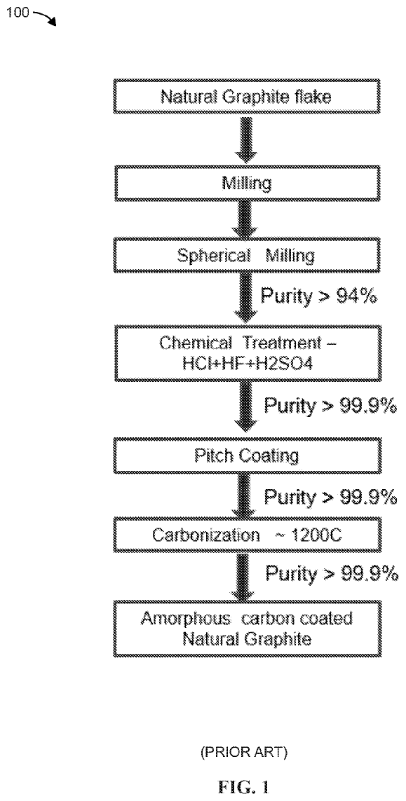

FIG. 1 illustrates a schematic flow diagram for a conventional process 100 for producing a material for making a graphite electrode. The conventional process 100 includes an acid treatment step in order to improve a purity of the graphite. The graphite electrode is made by milling and shaping a natural graphite powder. Milling techniques such as milling, and spherical milling may be employed. The milled and shaped graphite powder is treated with an acid to leach out the impurity. The acid wash may include any or a combination of organic and inorganic acids, such as, without limitations, hydrofluoric acid (HF), hydrochloric acid (HCl), sulfuric acid (H2SO4), nitric acid (HNO3), etc. The treated graphite powder is then coated with carbon source. The carbon source may be in the form of a pitch that is coated on the graphite powder. The pitch coated graphite powder is then heat treated to about 1200 degrees Centigrade (° C.) to effect carbonization of the carbon source coated graphite powder. The electrode obtained is an amorphous carbon coated natural graphite powder. The purity of the obtained electrode material may be as greater than about 99.95%.

However, the process 100 requires large quantities acid and water, and may further require an effluent treatment plant in order to effectively remove traces of acid before discharging the water. The resources required make the process expensive, and cumbersome. Further, the use of strong acids may pose an environmental hazard.

Thus, there may be a requirement for a means to produce or manufacture a graphite electrode that does not require large quantities of acid and water.

JP3534391 and U.S. Pat. No. 5,344,726 provide a process for amorphous carbon coatings on a surface of crystalline graphite processed into a spherical shape. In this process, propane, methane, acetylene, or benzene as hydrocarbon precursor, is pyrolytically deposited on a heated surface of graphite to produce active negative electrode material in which core crystalline carbon is coated with turbostratic amorphous carbon.

JP3193342 and KR101091547 provide carbon precursors such as coal tar pitch, formaldehyde-based resin, heat-treated pitch, vinyl-based resins, nitrogen- and sulfur-containing heterocyclic compounds, and the like. In this case, the graphite pitch mixer dispersion has a pitch content of 1 to 10 parts by weight based on 100 parts by weight of graphite. The obtained pitch-coated graphite has a fixed carbon ratio of the carbon coating layer that is 0.5-5 in weight ratio in comparison to the graphite.

JP2005515957 and U.S. Pat. No. 9,096,473 provide a means to produce artificial graphite active negative electrode from the cokes coated with petroleum pitch through a liquid medium.

U.S. Pat. No. 6,596,437 provides a chemical combination route to attain a coated active material. The process involves non-aqueous or organic solvents to prepare the amorphous carbon precursor as a coating material. Such a process demands the usage of large quantities of organic solvents and evaporating it, which makes the production method cumbersome. Further, due to use of organic solvents in mass production, environmental issues such as solvent recovery may be limitations.

As a result, it is advantageous to provide a process for carbon coating by a dry method free of enormous quantity of hazardous solvents. The present disclosure provides a process for manufacture a material for making graphite electrodes, where a natural graphite powder is milled and shaped, coated with pitch, and then carbonized/graphitized at very high temperatures of greater than about 2600° C. in order to remove impurities and also convert the pitch on graphite into graphitic carbon on graphite particle. Such a process yields a graphite powder with a high purity content. In some cases, the purity content from such a process may be equal to or greater than 99.95%.

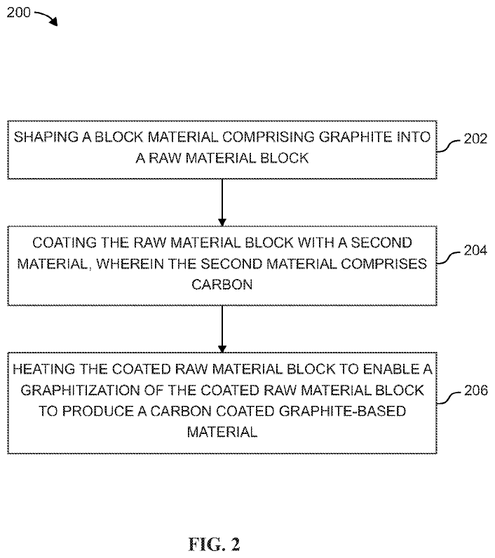

FIG. 2 illustrates a schematic flow diagram for a method to manufacture a graphite-based material for an electrode, according to an embodiment of the present disclosure. At step 202, the method 200 includes shaping a block material including graphite into a raw material block. At step 204, the method 200 include coating the raw material block with a second material, wherein the second material includes carbon. At step 206, the method 200 includes heating the coated raw material block to enable a graphitization of the coated raw material block to produce a carbon coated graphite-based material.

In some embodiments, the block material includes a natural graphite flake.

In some embodiments, the block material is shaped using any or a combination of milling and spherical milling.

In some embodiments, the second material includes pitch.

In some embodiments, the coated raw material block is heated to a temperature of between about 2500 degrees Centigrade (° C.) and 3000° C.

In some embodiments, the produced carbon coated graphite-based material has a tap density of between about 1.1 grams per cubic centimeter (g/cc) and about 1.25 g/cc.

In some embodiments, the produced carbon coated graphite-based material has a capacity of between about 360 milliampere-hour per gram (mAh/g) and about 370 mAh/g.

In some embodiments, the produced carbon coated graphite-based material has a purity equal to greater than about 99.95%.

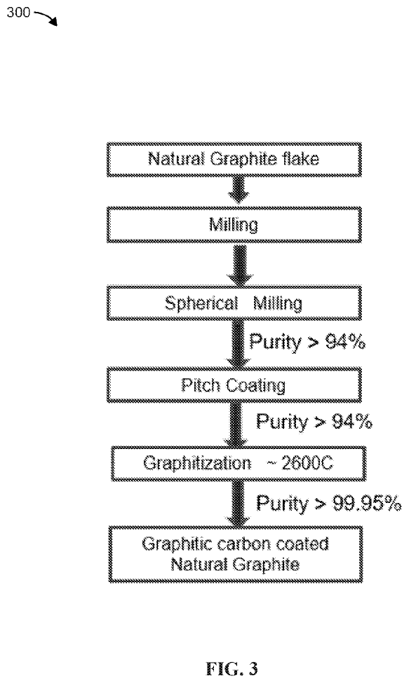

FIG. 3 illustrates an exemplary schematic flow diagram for a process 300 for producing a material for making a graphite electrode. The process 300 may include shaping and milling a natural graphite flake. Milling techniques such as milling, and spherical milling may be used. The milled and shaped graphite powder may then be coated with pitch. Here, pitch may function as a source for carbon. The pitch coated graphite flake is then heat treated to a temperature of about 2600° C. to effect a graphitization of the coated graphite flake. The resulting material is a graphitic carbon coated natural graphite. The resulting material may have a purity of greater than about 99.95%.

Further, the process 300 provided additional advantages. The obtained material has high tap density, which may help in easy dispersion and coating in an electrode making process. Furthermore, the process 300 does not require use of strong acids for purification of graphite. Hence, there may be no requirement for an effluent treatment plant. Further still, the process 200 also results in savings of water.

In the process 300, since the graphite powder is heated to very high temperatures, any impurities trapped within pores of the material are also evaporated due to the heat, thus resulting in a material with greater purity.

Table-1 below provides an exemplary comparison of characteristics of different samples of materials used for making graphite electrodes. Here, sample 1 may be material obtained from the conventional process 100 of FIG. 1. Samples 2 and 3 may be obtained from the process 300. Sample 4 may be similar to samples 2, and 3, but with an added step of additional coating of pitch, followed by carbonization. Each of the samples has an average particle size (D50) of about 10 microns.

TABLE 1
Characteristics of different samples of materials for making graphite electrode.

| | | Purity | Capacity | Efficiency | Tap Density |
|---|---|---|---|---|---|
| Sample | Process | (%) | (mAh/g) | (%) | (g/cc) |
| Sample 1 | Acid Purified | 99.9 | 362 | 92 | 1.05 |
| Sample 2 | Thermal Purified (2700° C.) | 99.95 | 364 | 93 | 1.10 |
| Sample 3 | Thermal Purified (2800° C.) | 99.97 | 366 | 94 | 1.15 |
| Sample 4 | Thermal Purified (2800° C.) + | 99.95 | 362 | 93 | 1.25 |
| | Pitch coated and | | | | |
| | carbonized (1200° C.) | | | | |

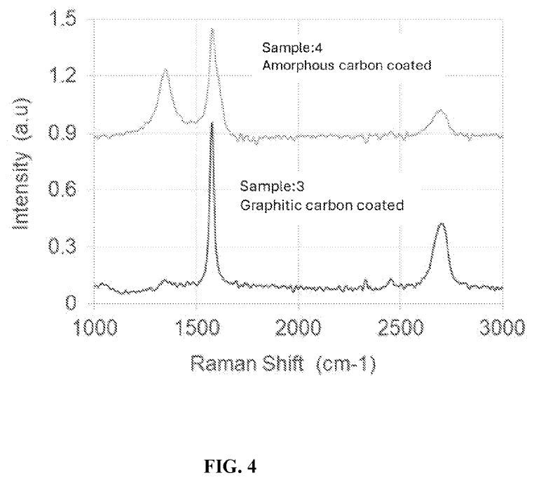

FIG. 4 illustrate the Laser Raman spectroscopy of (Sample-3) graphitic carbon coated Graphite powder and (sample 4) amorphous carbon coated graphite powder. Laser Raman spectroscopy is a sensitive technique to distinguish the surface structural fingerprints of different graphite materials, mainly to disorders and degree of graphitization. Raman spectra were recorded from the surface for graphitic, and amorphous carbon coated graphite anode materials are shown in the FIG. 4. The first order G-band is positioned at 1577 cm⁻¹ for both graphitic carbon coated graphite anode material and amorphous carbon coated graphite anode material, and it is corresponding to the E_{2g} vibration of sp² carbon domains, which represents the ordered structure of graphitic planes. The higher G-band intensity and full width half-maximum (FWHM_{G}) correspond to the degree of graphitization of carbon materials. As shown in FIG. 4. the (sample-3) graphitic carbon coated graphite powder sample indicated the sharp, intense G-band with a lower value of FWHM_{G} (23 cm⁻¹) suggesting minimal in-plane defect concentration and high level of graphitization compared to sample-4 with higher FWHM_{G} (51 cm⁻¹) of amorphous carbon coated sample.

The integrated ratio of ID/IG intensity is related to the degree of in-plane defects carbon materials. The sample-3 shows lower D-band intensity with lower I_{D}/I_{G} of 0.07. This indicates that Graphite surface is coated with highly ordered Graphitic carbon. The sample-4 shows higher ratio of I_{D}/I_{G}, which indicates that the surface of graphite is coated with amorphous carbon.

In another aspect, the present disclosure provides an electrode made from a graphite-based material. The graphite-based material is manufactured by milling and shaping a flaky material including graphite flakes into spherical graphite powder. The spherical graphite powder is further manufactured by coating the raw material block with a second material, wherein the second material includes pitch. The graphite-based material is further manufactured by heating the pitch coated raw material graphite powder to enable a graphitization of the coated raw material block to produce a graphitic carbon coated graphite-based material.

In some embodiments, the electrode has an efficiency of between about 92% and about 95%.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### ADVANTAGES OF INVENTION

The present invention provides a method to manufacture a graphite-based material for making an electrode to be used in secondary battery.

The present invention provides a method to manufacture a high-purity graphite-based material for an electrode to be used in secondary battery.

The present invention provides a method to manufacture a high purity graphite-based material for an electrode that is eco-friendly.

The present invention provides a method to manufacture a graphite-based material for an electrode that has a high tap density.

We claim:

1. A method (200) of manufacturing a graphite-based material for an electrode, the method (200) comprising the steps of:
shaping a flaky material comprising graphite into a spherical graphite powder;
coating the spherical graphite powder with a second material, wherein the second material comprises carbon; and heating the pitch coated material to enable graphitization of the coated raw material to produce a graphitic carbon coated graphite-based material.

2. The method (200) as claimed in claim 1, wherein the flaky material comprises a natural graphite flake.

3. The method (200) as claimed in claim 1, wherein the block material is shaped using any or a combination of milling and spherical milling.

4. The method (200) as claimed in claim 1, wherein the second material comprises pitch.

5. The method (200) as claimed in claim 1, wherein the coated raw material block is heated to a temperature of between about 2500 degrees Centigrade (° C.) and 3000° C.

6. The method (200) as claimed in claim 1, wherein the produced carbon coated graphite-based material has a tap density of between about 1.1 grams per cubic centimeter (g/cc) and about 1.25 g/cc.

7. The method (200) as claimed in claim 1, wherein the produced carbon coated graphite-based material has a capacity of between about 360 milliampere-hour per gram (mAh/g) and about 370 mAh/g.

8. The method (200) as claimed in claim 1, wherein the produced carbon coated graphite-based material has a purity equal to greater than about 99.95%.

9. The method (200) as claimed in claim 1, wherein the graphitic carbon coated graphite material produced exhibits a lower ID/IG ratio of 0.07.

10. An electrode made from a graphite-based material, wherein the graphite based-material is manufactured by:
shaping a block material comprising graphite into a raw material block;
coating the raw material block with a second material, wherein the second material comprises carbon; and
heating the coated raw material block to enable a graphitization of the coated raw material block to produce a carbon coated graphite-based material.
